(19) United States
(12) Patent Application Publication
(10) Pub. No.: US 2016/0066212 A1
(43) Pub. Date: Mar. 3, 2016

(54) SYSTEM AND METHOD FOR BROADCASTING ENCODED BEACON SIGNALS

(71) Applicant: Ashoka Sathanur Visweswara, Amstelveen (NL)

(72) Inventor: Ashoka Sathanur Visweswara, Amstelveen (NL)

(21) Appl. No.: 14/838,720

(22) Filed: Aug. 28, 2015

Related U.S. Application Data
(60) Provisional application No. 62/044,261, filed on Aug. 31, 2014.

(51) Int. Cl. H04W 28/06; H04W 4/00; H04W 72/04; H04L 29/06; H04L 12/721

(52) U.S. Cl. CPC H04W 28/065; H04L 65/4076; H04L 45/72; H04W 72/0446; H04W 4/008; H04L 2209/34

(57) ABSTRACT

A method for broadcasting a beacon message by checking size of the beacon message by a beacon generation device to determine if that is greater than a specific size and then splitting the beacon message into two or more message chunks having a size less than or equal to the specific size, if the size of the beacon message is found to be greater than the specific size. The message chunks are then encoded as per a message format with multiple fields to include a message data field and packet identifiers before transmitting the message chunks sequentially in consecutive time slots through a wireless protocol. The message chunks are reassembled by mobile computing devices listening to the beacon message broadcast to regenerate the beacon message.

### FIELD OF THE INVENTION

The present invention relates generally to wireless communication. More particularly, the present invention relates to advertisement beacon signals.

### BACKGROUND OF THE INVENTION

In today's world, wireless connectivity, particularly local wireless connectivity (Personal Area Networks), has opened up many avenues for the business or commercial houses to connect with the existing or prospective clients/customers/consumers/visitors. In case of local wireless connectivity, beacons are being increasingly used for broadcasting messages. These messages can be sent for the purpose of advertising or for sending any other information to mobile computing devices such as smart phones coming within a certain range of the broadcasting beacons. There are various short-range wireless protocols that exist in the market today and Bluetooth is one of those.

Bluetooth Low Energy (BLE or BTLE) has 4 basic modes in which it operates in—master device mode, slave device mode, advertising mode, and scanning mode. Advertising mode is used by the BLE device to periodically advertise information. While operated in this mode, a BLE device can be used for general, unacknowledged advertisements that can be detected by any mobile device such as a mobile phone with its Bluetooth receiver turned on when it comes within the range of transmission. Since, a BLE device can run on very low power (e.g. on a coin cell) for a long time, it makes BLE beacons cheaper and even more economically attractive.

In case of Bluetooth Low Energy (BLE), 40 channels, spaced 2 MHz apart, are used to operate in the 2.4 GHz ISM band. However, in advertising mode, BLE uses only 3 of the 40 channels to advertise. There are 2 types of packets used in transmitting BLE beacon messages, Data and Advertise, each with variable lengths. BLE Data packets consist of an 8 bit preamble, 32 bit access codes that are defined by the RF channel used, a variable Protocol Data Unit (PDU) ranging from 2-39 bytes and a 24 bit CRC. On the other hand, advertise packets have PDU containing a 16 bit header and up to 31 bytes of data. When a peripheral, i.e. the device which broadcasts, wants to broadcast in the advertising mode, the same advertise packet is transmitted sequentially on each of the three advertising channels, namely on channel 37, 38 and 39 corresponding to frequencies 2402 MHz, 2426 MHz and 2480 MHz respectively. Devices operating as scanners (e.g. smart phones) will detect one of these, and pass the information it contains to the higher level protocol stack and application. So, it is obvious that there is a restriction on the payload while broadcasting a longer single message through BLE beacons. This is a great disadvantage considering the fact that broadcasters would want to broadcast longer, richer contextual messages. There exists many technologies in this field like Apple's iBeacon and others, but none addresses this problem.

Consequently, there exists in the art a long felt need for a system and method by means of which powerful long contextual beacon messages can be broadcasted even without the transmitter and the receiver being paired. There also exist in the art a long felt need for a system and method for broadcasting the messages in a secure manner.

### OBJECTS OF THE INVENTION

It is an object of the present invention to provide a system and method for broadcasting long contextual messages through wireless communication.

Another object of the present invention is to provide a system and method for broadcasting long contextual messages in local wireless network or in personal area network.

A further object of the present invention is to provide a system and method for broadcasting beacon messages in a secured way.

A still further object of the present invention is to provide a system and method for broadcasting long contextual message through any type of wireless protocol.

Yet another object of the present invention is to provide a system and method for broadcasting long contextual message without establishing connection between the transmitter and the receiver.

These as well as other objects of the present invention are apparent upon inspection of this specification, including the drawings and appendices attached hereto.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The system and method of the present invention is directed to broadcasting of beacon signals. Although the concept of the present invention is described herein with reference to Bluetooth Low Energy (BLE or BTLE) protocol, it can be extended to work on the other wireless protocols also. In BLE, advertising beacons are used extensively at places like stores, shopping malls, public places etc. whereby short messages can be broadcasted using a transmitter and, when a Bluetooth enabled device with Bluetooth module switched on comes within the range of beacon transmission, the device can listen to the beacon transmission and receive the signals. However, BLE advertising beacons has some limitations in terms of a message size it can transmit. With the help of the system and method of the present invention, a long contextual message can be split into number of smaller chunks if its data size exceeds the limit permissible in one BLE advertising beacon message. These chunks, after encoding and encrypting, can be transmitted in sequence. At the receiver, which can be a mobile computing device like a smart phone, the received message chunks are reassembled according to the defined message sequence contained in the messages, after decrypting and decoding, and then the complete message in reconstructed to make it available for viewing to the user of the mobile computing device.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 shows a general format of a Bluetooth Low Energy advertising packet;

FIG. 2A shows an exemplary advertisement beacon packet structure in accordance with one embodiment of the present invention;

FIG. 2B depicts an exemplary way of splitting a long encoded message data into smaller chunks in accordance with one embodiment of the present invention;

FIG. 3A shows an exemplary sequence for transmitting multiple chunks of one encoded message data in accordance with one embodiment of the present invention;

FIG. 3B shows full packet data for multiple chunks of one exemplary Bluetooth low energy advertisement packet in accordance with one embodiment of the present invention;

FIG. 4A illustrates an exemplary method of message encoding in a BLE advertising beacon packet in accordance with one embodiment of the present invention;

FIG. 4B shows one possible format for last of the advertising beacon packet message chunks in accordance with one embodiment of the present invention;

FIG. 5 is a flowchart for BLE advertising beacon broadcasting in accordance with one embodiment of the present invention;

FIG. 6A shows a method of transmitting different advertising beacon messages to mobile computing devices based on different proximity regions in accordance with one embodiment of the present invention;

FIG. 6B shows a method of transmitting different advertising beacon messages to mobile computing devices from more than one broadcasting devices in accordance with one embodiment of the present invention;

FIG. 7 shows a method of transmitting same or different advertising beacon messages to mobile computing devices from more than one broadcasting devices in accordance with one embodiment of the present invention;

FIG. 8 illustrates an exemplary block diagram of a BLE beacon device or wireless device in accordance with one embodiment of the present invention; and

FIG. 9 illustrates an exemplary block diagram of a sensor device in accordance with one embodiment of the present invention.

### DETAILED DESCRIPTION OF THE INVENTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Although, the system and method of the present invention is described herein with reference to Bluetooth Low Energy protocol, it is to be understood that the concept of the present invention can be accomplished through other wireless protocols also such as through Wifi, Zigbee, UWB etc.

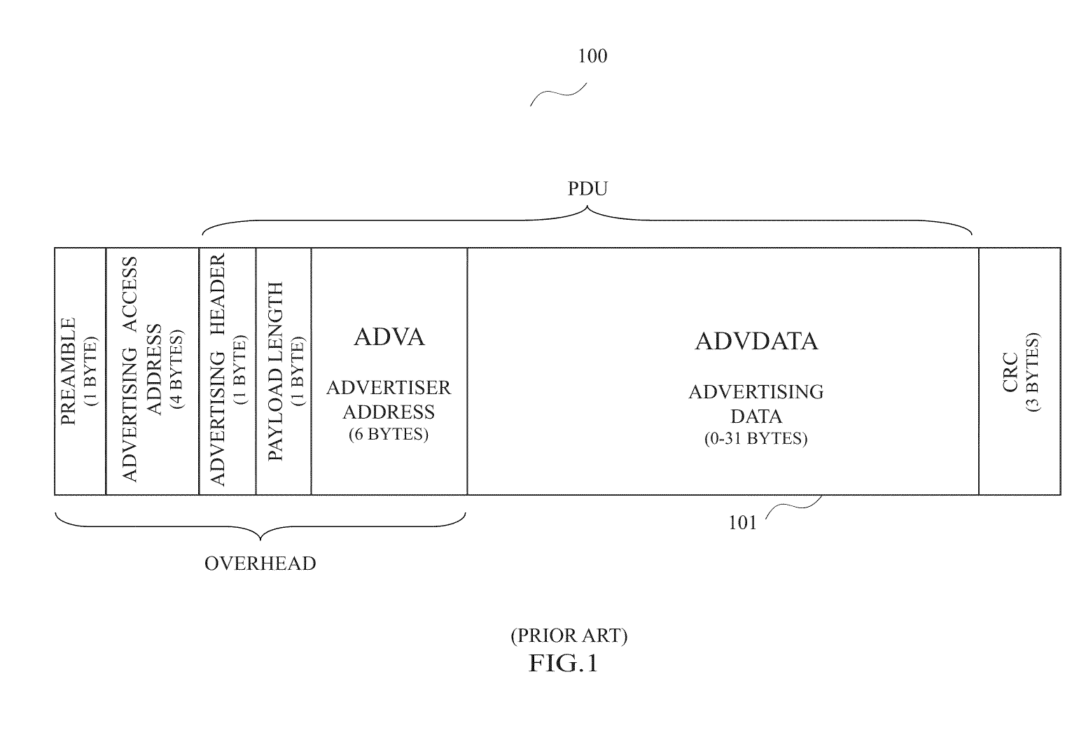

FIG. 1 shows a general format of a Bluetooth Low Energy advertising packet 100. As can be seen in FIG. 1, the advertising data (ADVDATA) field 101 can accommodate a maximum of 31 bytes only in this format. Therefore, it obvious that there is a restriction on broadcasting a message through BLE advertising packet if its size exceeds 31 bytes. Hereinafter, the terms “advertising packet”, “beacon packet” and “beacon message” are used interchangeably and alternatively.

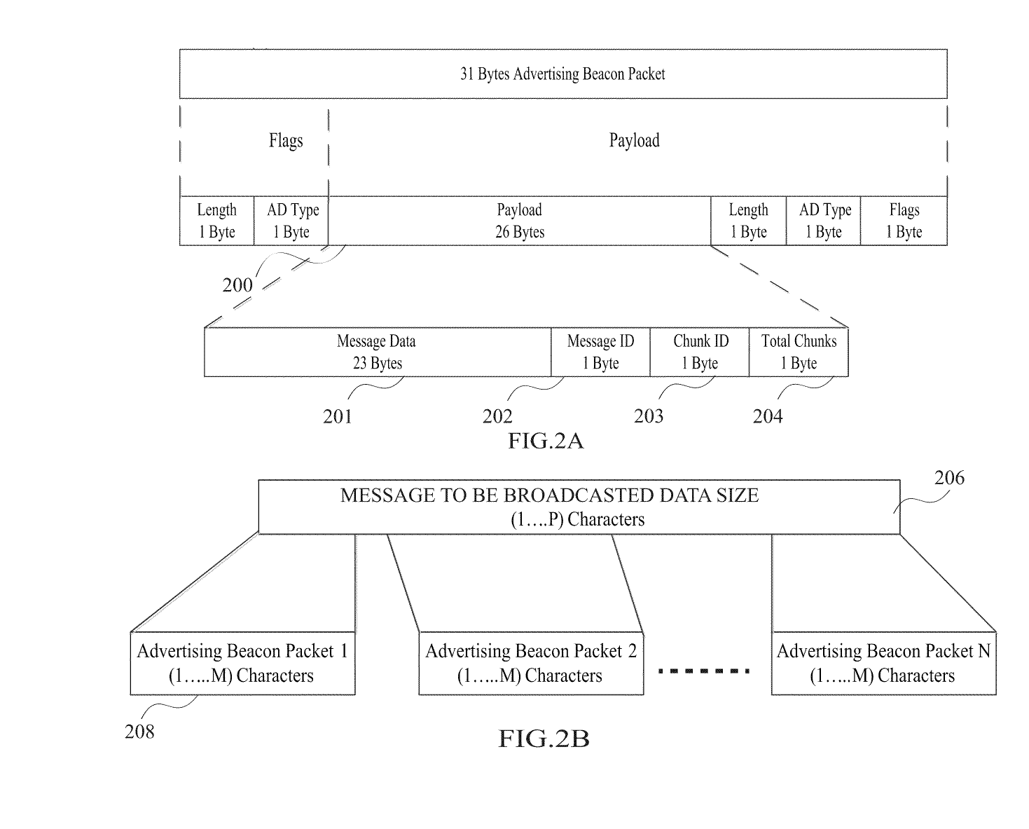

As shown in FIG. 2A, out of these 31 bytes of advertising data, one possible advertisement packet format, in accordance with an embodiment of the present invention, allows for 26 bytes for message payload 200. The rest of the bytes are used as per the BLE advertisement packet specification.

To be able to transmit longer than 26 bytes of data, the device 800 of the present invention splits the beacon message into two or more chunks and adds additional packet identifiers to the chunks to define a message format for each of the chunks. The addition of packet identifiers during beacon message decomposition at the transmitter end facilitates reassembly of the chunks at the receiver end to reconstruct the beacon message. This is however one possible way to identify multiple packets of the same message. In one exemplary embodiment, out of the 26 bytes of message payload 200, 23 bytes are used for message data 201 and the rest are used for adding the packet identifiers in the chunk message format. In a preferred embodiment, 1 byte is used each for Message ID 202, Chunk ID 203 and Total Chunks 204 respectively as packet identifiers. Message ID identifies the advertisement packet as belonging to the wireless protocol of the present invention, Chunk ID denotes which part of the total message this packet represents and the total number of chunks denotes total number of advertisement packets which are used to compose the full message.

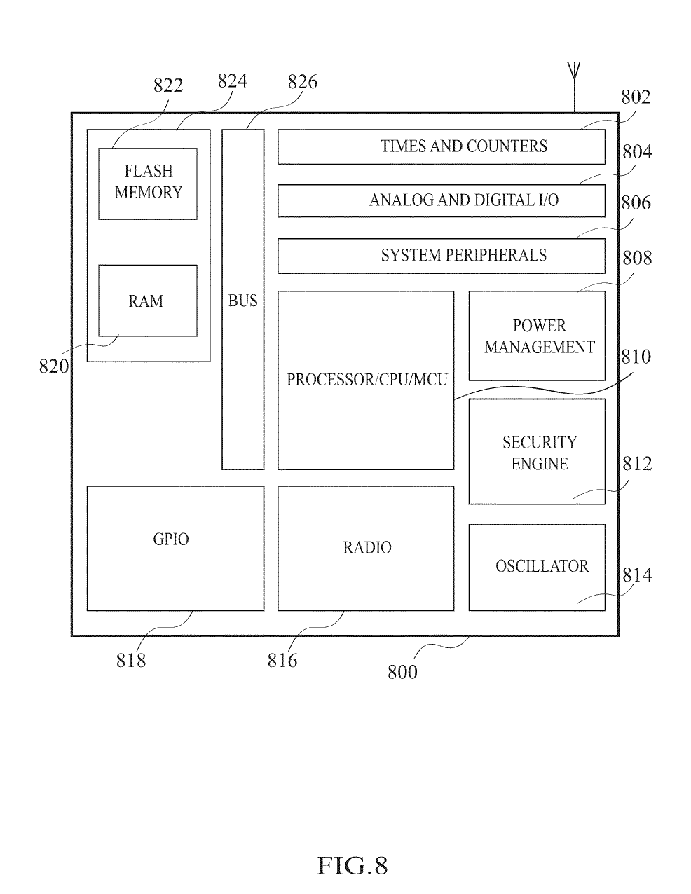

FIG. 8 shows the general architecture of a wireless device 800 for implementing the system and method of the present invention according to one preferred embodiment. The wireless device 800 comprises one or more times and counters 802, an analog and digital input/output component 804, one or more system peripherals 806, a power management unit 808, a processor (also referred to as CPU and MCU) 810, a security engine 812, an oscillator 814, a radio unit 816, a General-purpose input/output (GPIO) 818, a computer readable storage medium 824, the media 824 further comprising random access memory (RAM) 820 and a flash memory 822 and a bus 816 to interconnect these components. The components appearing in the wireless device 800 refer to an exemplary combination of those components that would need to be assembled to create the infrastructure in order to provide the tools and services contemplated by the present invention. This device 800, referred to as a beacon generation device hereinafter, may be specially constructed for the desired purposes and/or can be in the form of a monolithic integrated circuit component or it may comprise a general purpose mobile computing device. The computer readable storage medium 824 stores one or more computer programming logic that, when executed on the processors 810, causes the beacon generation device/wireless device 800 to carry out one or more functions related to the method of broadcasting an encoded beacon message in accordance with an embodiment of the present invention. The wireless device 800 may selectively activated or reconfigured by a computer program stored in the device with addition of few hardware and software. Such a computer program may be stored in the computer readable storage medium 824. The wireless device 800 can be a free standing device which can be battery powered or USB powered or powered by any other power source. The wireless device 800 can also be part of a bigger system such as a smart phone or a tablet or a laptop or any other form of mobile computing device.

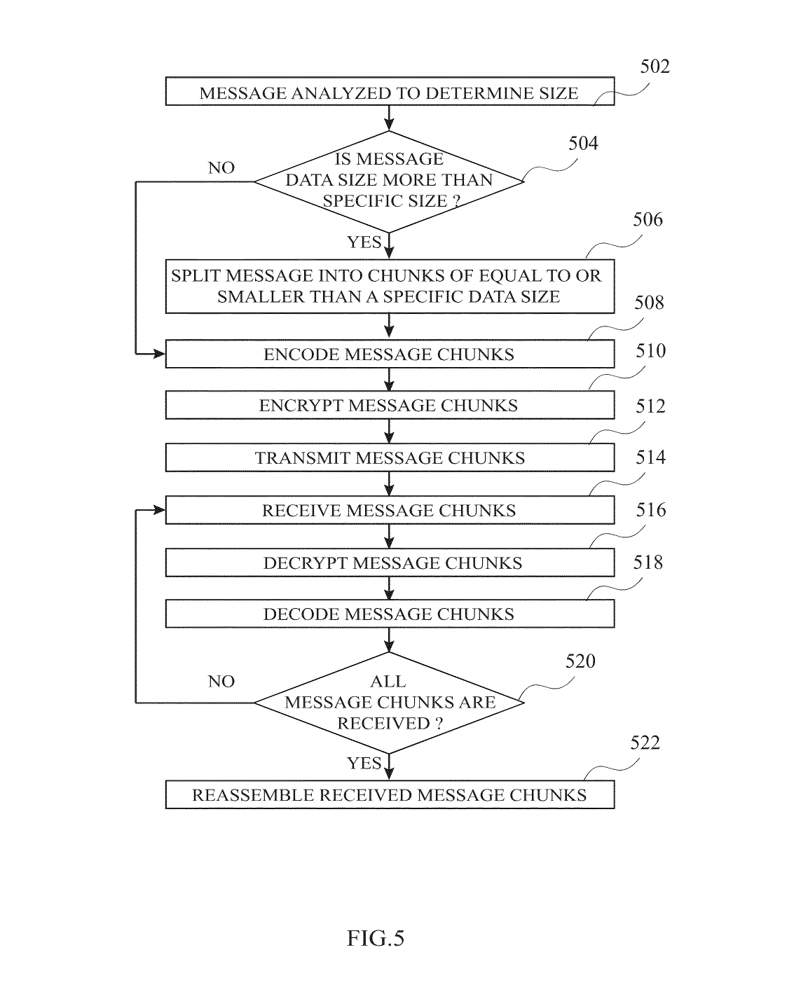

Reference to FIG. 5, as in step 502, when a beacon message in entered for transmission through the wireless device (beacon generation device) 800, the beacon message is checked for its size in accordance with one preferred embodiment of the present invention as in step 504. For example, suppose a message “Dear Customer, Welcome to Palace, Today's offer: Buy two sandwiches of your choice and get a smoothie for free!!” is what a food store wants to broadcast to its visitors. As this message is fed to the wireless device 800, it checks the size of the message in accordance with a preferred embodiment. In the present example, the total number of characters in the message is 112 or the message size is 112 bytes.

If the size of the beacon message is found to be greater than a predetermined specific size, as in step 504 of FIG. 5, the message is split into a number of smaller chunks of data. Reference to FIG. 2B, the message to be broadcasted 206 has P number of characters whereas the permissible data size in each BLE advertising beacon is M number of characters with M<P. Therefore, in a preferred embodiment of the present invention, the message to be broadcasted 206 has to be split into N number of advertising beacon packets 208 so that these N number of packets, each containing M number of characters, can accommodate all the content of the message 206.

As shown in FIG. 2A and FIG. 2B, the size M of the message data 201 in a BLE advertising packet can be of a maximum of 23 characters or bytes as per a preferred embodiment of the present invention. Accordingly, the predetermined specific size mentioned in step 504 of FIG. 5 can be set as 23 bytes in the wireless device 800. However in the future, if the wireless protocol allows for more number of characters in the advertisement packet in the ADVDATA, then the maximum size of the packet can be a different value.

In the present example, as the size of the message is 112 bytes, it is greater than the specified size of 23 bytes and, therefore, as in step 506, the message should be split into two or more multiple chunks of equal to or smaller than 23 byte size. Accordingly, as shown below, the message of the present example is split into 5 packets or chunks—from Packet/Chunk 1 to Packet/Chunk 5 each having equal to or less than 23 bytes of message data.

Packet/Chunk 1: “Dear Customer, Welcome”0x0F 0x00 0x04
Packet/Chunk 2: “to Palace, Today's offe” 0x0F 0x01 0x04
Packet/Chunk 3: “r: Buy two sandwiches o”0x0F 0x02 0x04
Packet/Chunk 4: “f your choice and get a”0x0F 0x03 0x04
Packet/Chunk 5: “smoothie for free!!”0x0F 0x04 0x04

The message data for each advertising beacon packet, after splitting, is denoted with the text between the quotation marks as shown above. The HEX code 0x0F is the message ID 202 and the next byte after message ID byte is HEX code between 0x00 to 0x04 which is the chunk ID number 203 and the last byte denotes the total number of chunks 204 in the message which is five in this example.

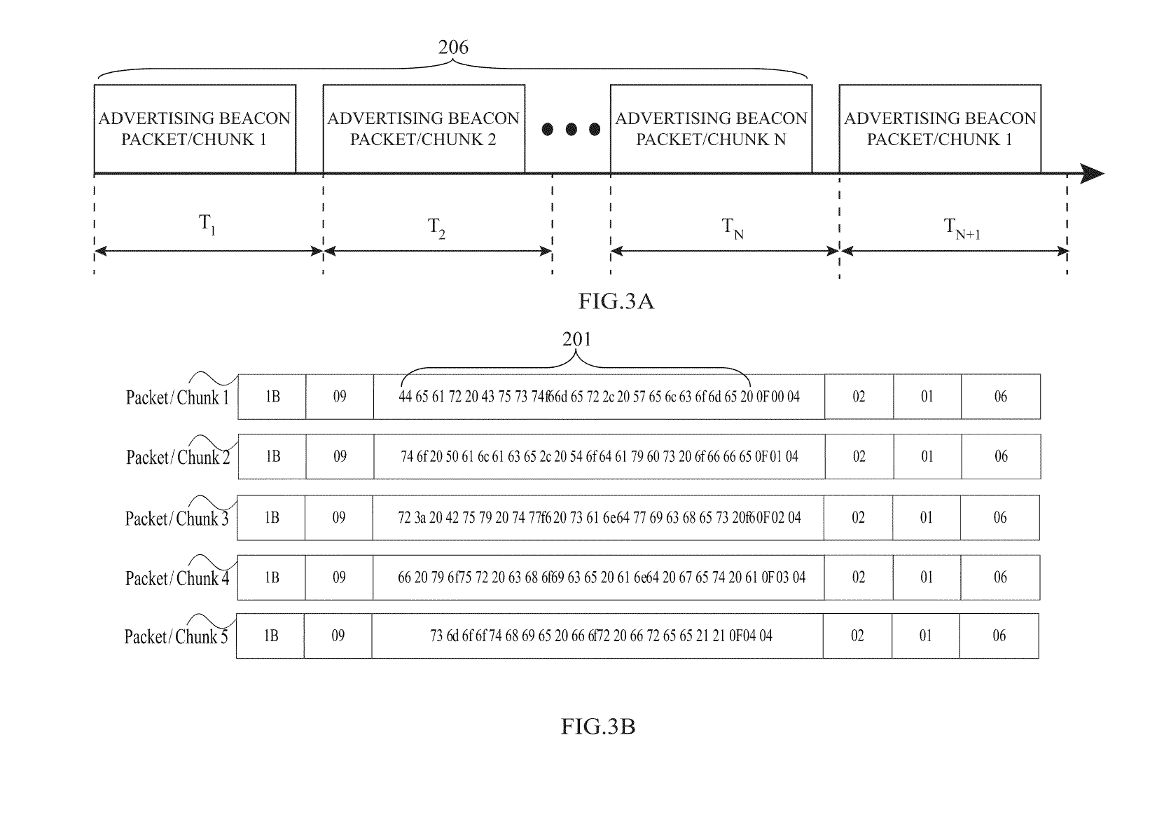

FIG. 3B shows the five numbers of message packets (Packet/Chunk 1 to Packet/Chunk 5) in Bluetooth low energy advertisement packet format split from a single exemplary message “Dear Customer, Welcome to Palace, Today's offer: Buy two sandwiches of your choice and get a smoothie for free!!” with the help of wireless device 800. The packet data is shown in hexadecimal code (HEX Code) with the message data 201 followed by message ID, chunk ID and total number of chunks.

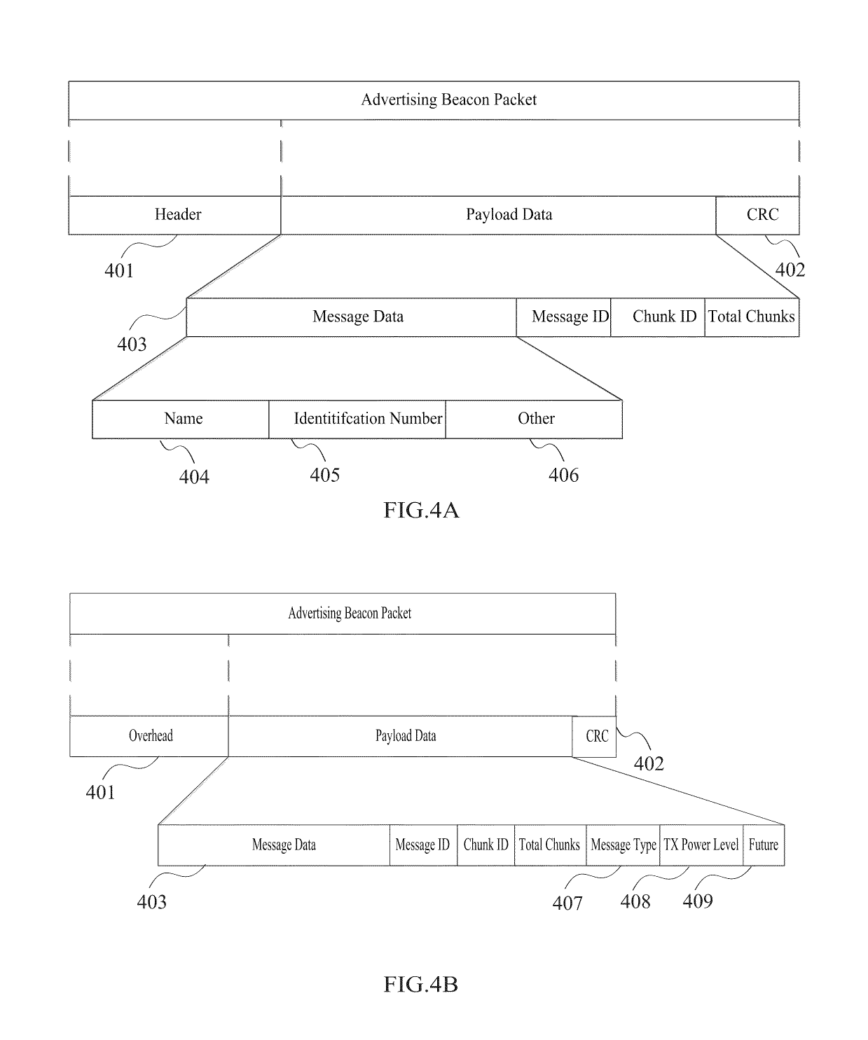

FIG. 4A shows one possible implementation of encoding the BLE beacon packets in accordance with some embodiments of the present invention as in step 508 of FIG. 5. The Header bytes 401 are wireless protocol specific which include Flag bytes, Length bytes, Preamble bytes etc. The CRC field 402 is the Cyclic Redundancy Check used for error detection and correction. The payload data available in the advertising beacon packet is further divided into multiple fields to help for proper message assembly on the receiver's side in accordance with an embodiment of the present invention. In one possible implementation of the payload structure shown in FIG. 4A, the payload data has a “Message Data” field 403 of one or more bytes which is a part of the complete encoded message data to be transmitted. In the example shown in FIG. 4A, the “Message Data” field is split into three parts, “Name” field 404 of one or more bytes, “Identification Number” 405 of one or more bytes and “Others” field 406 of one or more bytes. In some embodiments, the message encoding can be done through any of the standard encoding schemes known in the art such as ASCII, Universal character encoding or special encoding schemes etc. tailor made for a specific application or compression techniques can also be used to encode the message. In a preferred embodiment of the present invention the messages are also encrypted to provide extra layer of security in message broadcasting as in step 510.

In accordance with an embodiment, the final part of the message present in the last message chunk (i.e. packet/chunk 5 in the present example) received in the advertisement packet can have additional fields which are very specific to the type of the complete long encoded message received. One possible implementation of the last chunk format of the message is shown in the FIG. 4B. The last message chunk, as shown in FIG. 4B, can have additional fields to identify the full message when reconstructed back at the receiver side. The “Message Type” field 407, which is of one or more bytes, indicates what type of encoded message the message chunk represents. Table below shows some examples of message type 407 indicators that can be transmitted using the system and method of the present invention.

| Message Type Field [Hex] | Message Data |
|---|---|
| 0x10 | URL of a web resource |
| 0x20 | Text message |
| 0x30 | GPS co-ordinate |
| 0x40 | Contact Details |
| 0x50 | Part of a URL |
| 0x60 | Mobile text message |
| 0x70 | Secure code |
| 0x80 | Sensor Data |

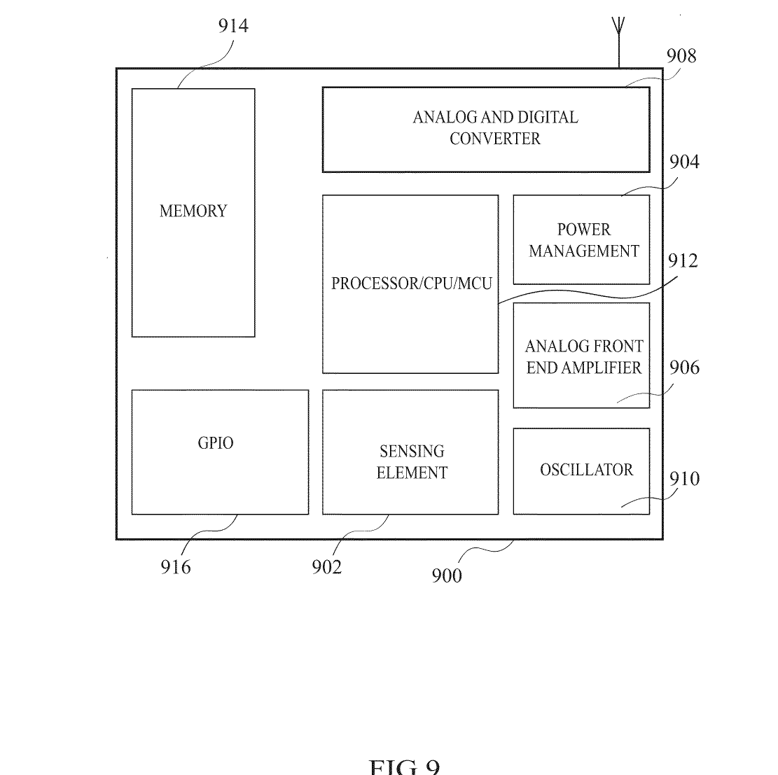

In one embodiment of the present invention, a sensor data can be obtained from a sensor device. As shown in FIG. 9 the sensor device 900 comprises of the following components but not limited to only those shown in the FIG. 9. Examples of the sensing element 902, which performs a particular sensing, include, but not limited to, a current sensor to measure current flow, a temperature sensing element to measure temperature, an accelerometer which senses movement etc. The sensor device 900 may further comprise a power management module 904, an analog front end amplifier 906, an analog to digital converter 908, an oscillator 910, a microprocessor/MCU/CPU 912 to process the digitized sensor data, a memory 914 to store the sensor data and a General-purpose input/output (GPIO) 916 to interface the sensor to the external world.

The sensor device 900 can be battery powered or USB powered or powered by any other power source. The sensor device 900 can also be part of a bigger system such as a smart phone or a tablet or a laptop or any other form of mobile computing device.

In another embodiment of the present invention, a message can also consist of concatenation of two or more different types of messages (as shown in the Message Type Field) in a single transmitted message. As an example, a message can be “Dear Customer, Welcome to Palace, Today's offer: Buy two sandwiches of your choice and get a smoothie for free!! www.palace.com/offers” which has two types of messages, the first part is text message while the second part is a URL.

Reference to FIG. 4B, the “TX Power Level” field 408 is of one or more bytes and it indicates the power level with which the message was transmitted. “Future” field 409 is of one or more bytes and is reserved for future expansion.

After encoding and encryption of the data, the message chunks are transmitted by the wireless device 800 as in step 512 of FIG. 5 in a wireless protocol in accordance with an embodiment of the present invention. FIG. 3A represents the sequence for transmitting chunks i.e. packet/chunks 1 to packet/chunks N of a single encoded message data 206 in accordance with one embodiment of the present invention. FIG. 3A shows how the advertising beacon packets 1 to N transmit the complete P character of encoded message in consecutive time slots T₁ to T_{N} and then the transmission of all the packets are repeated in sequence.

As soon as a mobile computing device, such as a smart phone, with Bluetooth module switched on, comes within the range of beacon transmission of wireless device 800, it would start receiving the BLE advertising packets one by one as in step 514 in FIG. 5. The received chunks of messages are then decrypted and decoded as in steps 516 and 518 respectively. Until all the chunks including the last chunk or packet of the total number of split messages is received at the receiver end i.e. by the mobile computing device listening to the BLE beacon broadcast of the present invention, the chunks or packets would not be reassembled at the receiver end. As shown in FIG. 4B, as the beacon packet for the last of the split packets/chunks is unique in format in accordance with an embodiment of the present invention, the mobile computing device would wait till all the chunks including this message chunk is received to reassemble the message packets together as in step 520. Once all the message packets/chunks are received, the mobile computing device would reassemble the message packets as per the serial number of the message IDs contained in the packets till the total number of indicated packets/chunks are put in place as in step 522 and the complete message is presented. Based on the type of message received, respective actions will be taken by the mobile computing device. For example, if it's a URL, the corresponding URL is opened in a mobile browser. If it is a text message, it will be displayed on the display of the mobile computing device.

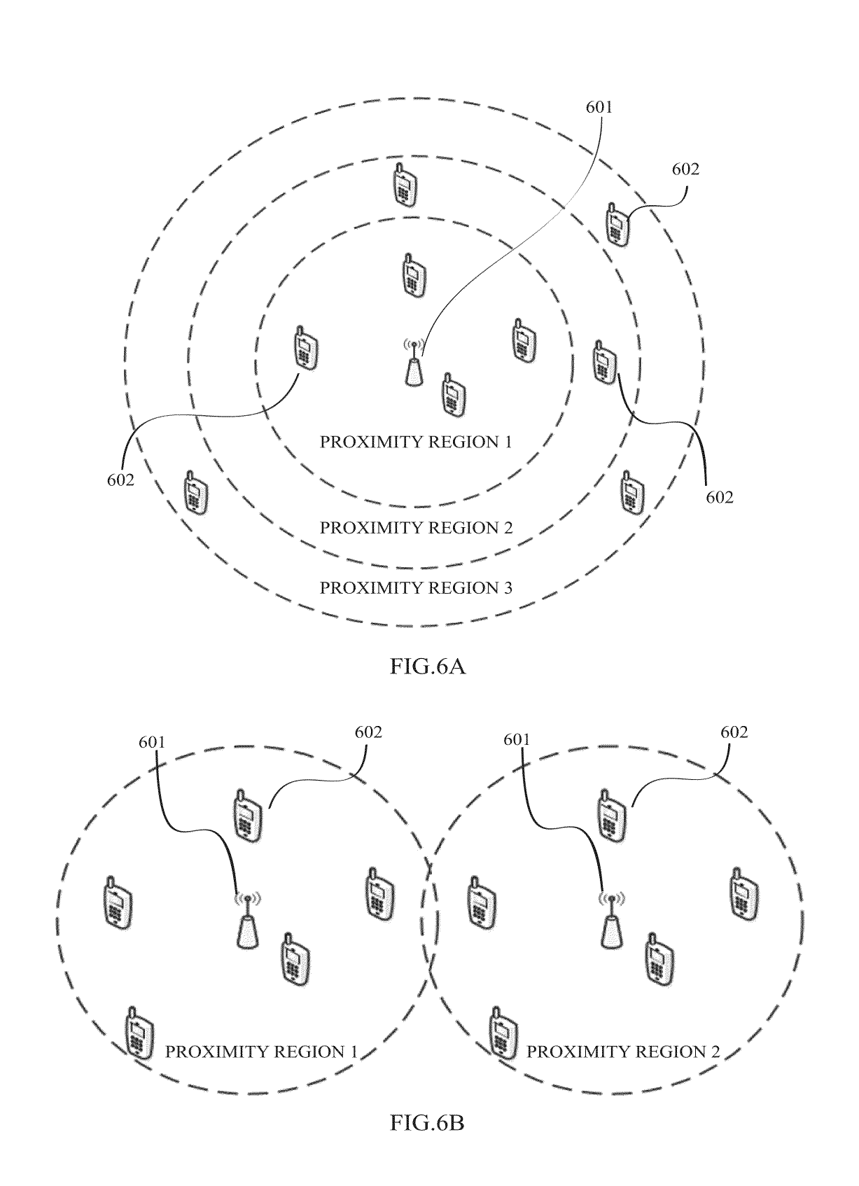

In a preferred embodiment, the system of encoded beacon broadcasting of the present invention works on the principle of a wireless device transmitting messages using broadcast beacon signals to mobile devices within a certain range/proximity region of the broadcasting device. The proximity region or range depends on the transmit power level (408 FIG. 4B) of the wireless device transmitting the messages. The transmit power level of the wireless broadcasting device can be altered in a periodic manner and, for each transmit power level, different messages are transmitted allowing for different messages to be delivered to the mobile devices based on which proximity region they lie. For example, FIG. 6A, shows three proximity regions (Proximity Region 1, Proximity Region 2 and Proximity Region 3) which can be created by periodically changing the transmit power level of the wireless broadcasting device 601. For different proximity regions, as a consequence of having different transmit power level, one can transmit different messages and hence mobile devices 602 based on which proximity region they lie, will receive the corresponding message.

In another embodiment of the present invention, as shown in FIG. 6B, two or more wireless broadcasting devices 601, positioned at different physical locations, can transmit identical messages in their corresponding proximity regions (Proximity Region 1 and Proximity Region 2 in the example) or can be transmitting different messages in their corresponding proximity regions.

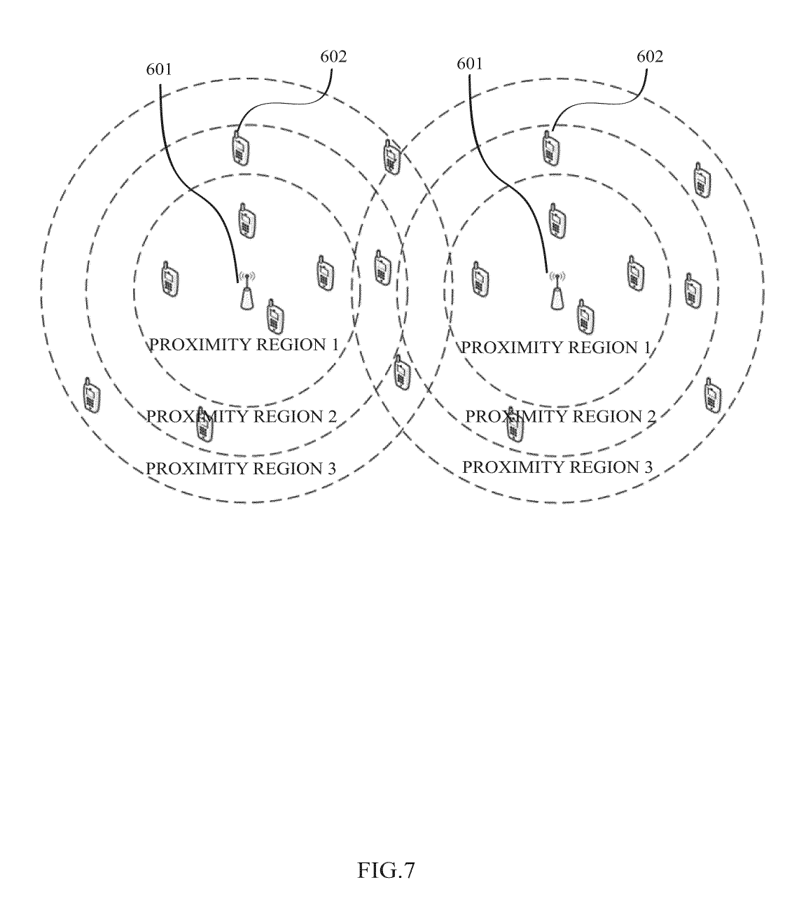

In yet another embodiment of the present invention, reference to FIG. 7, two or more wireless broadcasting devices 601, positioned at different physical locations, with multiple proximity regions (Proximity Region 1, Proximity Region 2 and Proximity Region 3 in the example) can transmit same message in each proximity region or different messages in different proximity regions. Each wireless broadcasting device can be either transmitting the same message or different messages.

The term “message” used herein may include, but not limited to, any electronic file or media file. Accordingly, the term “message” may include any text and non-text data.

Flowchart in FIG. 5 is used to describe the steps of the present invention. While the various steps in this flowchart are presented and described sequentially, some or all of the steps may be executed in different orders, may be combined or omitted, and some or all of the steps may be executed in parallel. Further, in one or more of the embodiments of the invention, one or more of the steps described herein may be omitted, repeated, and/or performed in a different order. In addition, additional steps, omitted in the flowchart may be included in performing this method. Accordingly, the specific arrangement of steps shown in FIG. 5 should not be construed as limiting the scope of the invention.

What is claimed is:

1. A method for broadcasting a beacon message, said method comprising:
checking, by a beacon generation device, size of said beacon message to determine if said size of said beacon message is greater than a specific size;
splitting, with said beacon generation device, said beacon message into two or more message chunks, each of said message chunks having a size less than or equal to said specific size, if said size of said beacon message is determined to be greater than said specific size;
encoding, with said beacon generation device, each of said two or more message chunks as per a message format, said message format divided into multiple fields comprising one or more packet identifiers and a message data field, wherein said one or more packet identifiers include a message ID, a chunk ID and an identifier to denote total number of said message chunks;
transmitting, by said beacon generation device, sequentially each of said two or more message chunks in consecutive time slots through a wireless protocol; and
reassembling, by one or more mobile computing devices, said message chunks according to said packet identifiers on receiving said two or more message chunks to regenerate said beacon message.

2. The method of claim 1, wherein said wireless protocol is a Bluetooth Low Energy protocol.

3. The method of claim 1, wherein said message ID denotes said wireless protocol and said chunk ID denotes which part of said beacon message each of said two or more message chunks represent.

4. The method of claim 1, wherein said message data field is further divided to include a name field, an identification number and an optional field for said encoding.

5. The method of claim 1, wherein final part of said two or more message chunks of said beacon message includes one or more additional fields to specify said beacon message.

6. The method of claim 5, wherein said one or more additional fields include a message type field for indicating a message type of said beacon message being broadcasted.

7. The method of claim 6, wherein said message type is a URL of a web resource, a text message, a GPS co-ordinate, a contact details, a secure code and a sensor data.

8. The method of claim 7, wherein said sensor data is obtained from a sensor device and said sensor device includes a sensor element for sensing one or more parameters for transmitting said sensor data as said beacon message.

9. The method of claim 6, wherein two or more of said message type indicated in said message type field concatenate two or more different messages at said mobile computing device.

10. The method of claim 1, wherein said multiple fields of said message format include a transmit power level which determines a proximity region around said beacon generation device within which said one or more mobile computing devices listen to said beacon message.

11. The method of claim 10, wherein said proximity region is altered and a plurality of proximity regions are created by changing said transmit power level to transmit same or different said beacon message.

12. A system for broadcasting a beacon message, said system comprising:
a beacon generation device, said beacon generation device configured to, at least;
check a size of said beacon message to determine if said size of said beacon message is greater than a specific size;
split said beacon message into two or more message chunks, each of said message chunks having a size less than or equal to said specific size, if said size of said beacon message is determined to be greater than said specific size;
encode each of said two or more message chunks as per a message format, said message format divided into multiple fields comprising one or more packet identifiers and a message data field, wherein said one or more packet identifiers include a message ID, a chunk ID and an identifier to denote total number of said message chunks;
transmit sequentially each of said two or more message chunks in consecutive time slots through a wireless protocol; and
one or more mobile computing devices to reassemble said message chunks according to said packet identifiers on receiving said two or more message chunks to regenerate said beacon message.

13. The system of claim 12, wherein said wireless protocol is a Bluetooth Low Energy protocol.

14. The system of claim 13, wherein said transmission of said message chunks occurs in an advertising packet of said Bluetooth Low Energy protocol.

15. The system of claim 12, wherein said message ID denotes said wireless protocol and said chunk ID denotes which part of said beacon message each of said two or more message chunks represent.

16. The system of claim 12, wherein final part of said two or more message chunks of said beacon message includes one or more additional fields to specify said beacon message.

17. The system of claim 16, wherein said one or more additional fields include a message type field for indicating a message type of said beacon message being broadcasted.

18. The system of claim 17, wherein said message type is a URL of a web resource, a text message, a GPS co-ordinate, a contact details, a secure code and a sensor data.

19. The system of claim 12, wherein said multiple fields of said message format include a transmit power level which determines a proximity region around said beacon generation device within which said one or more mobile computing devices listen to said beacon message.

20. A computer readable storage medium storing one or more computer programming logic that, when executed on a processor included in a beacon generation device, causes said beacon generation device to, at least:
check a size of a beacon message to determine if said size of said beacon message is greater than a specific size;
split said beacon message into two or more message chunks, each of said message chunks having a size less than or equal to said specific size, if said size of said beacon message is determined to be greater than said specific size;
encode each of said two or more message chunks as per a message format, said message format divided into multiple fields comprising one or more packet identifiers and a message data field, wherein said one or more packet identifiers include a message ID, a chunk ID and an identifier to denote total number of said message chunks; and
transmit sequentially each of said two or more message chunks in consecutive time slots through a wireless protocol.
